(19) United States
(12) Patent Application Publication
(10) Pub. No.: US 2022/0289503 A1
(43) Pub. Date: Sep. 15, 2022

(54) METHOD AND DEVICE FOR LOADING A MATERIAL IN LAYERS, AND SYSTEM COMPRISING SUCH A DEVICE

(71) Applicants: Jean-Luc SALLUSTRO, Trou-aux-Biches (MU); JUA GROUP LTD, Ebene (MU); JUA, Montpellier Cedex 2 (FR)

(72) Inventor: Jean-Luc SALLUSTRO, EAU BLEUE (MU)

(73) Assignee: JUA, MONTPELLIER CEDEX 2 (FR)

(21) Appl. No.: 17/639,625

(22) PCT Filed: Sep. 3, 2020
(86) PCT No.: PCT/FR2020/000231

§ 371 Date: Mar. 2, 2022

(30) Foreign Application Priority Data
Sep. 4, 2019 (FR) FR1909707

(51) Int. Cl. B65G 47/94; B65G 69/04

(52) U.S. Cl. CPC B65G 47/945; B65G 69/0416; B65G 2201/04

(57) ABSTRACT

A method and a device for loading a material in layers, in which a first fraction of the material intended to form a first layer is fed to a belt conveyor located above a loading zone, tilting the conveyor about its longitudinal axis such that the entire first fraction is poured into a receiving zone in a receptacle to form a first layer, feeding a subsequent fraction of the material intended to form a subsequent layer to the conveyor, and then tilting the conveyor about its longitudinal axis such that the entire subsequent layer is poured onto the receiving zone to thereby form the subsequent layer.

### CROSS REFERENCE TO RELATED APPLICATIONS

The present application is a National Stage Application of PCT International Application No. PCT/FR2020/000231 (filed on Sep. 3, 2020), under 35 U.S.C. § 371, which claims priority to French Patent Application No. FR1909707 (filed on Sep. 4, 2019), which are each hereby incorporated by reference in their respective entireties.

### TECHNICAL FIELD

The present invention relates to a method and a device for loading a material in layers. It relates more specifically, but not exclusively, to composting organic waste in a closed receptacle, particularly in a silo, bins, or corridors, with forced ventilation, controlled moistening, and phase separation.

### BACKGROUND

Numerous industrial methods, intended to treat materials, use loading of these materials in layers. As a non-limiting example, mention can be made of composting. However, the present invention can also be applied to other types of operations such as loading base layers for mushroom cultivation, seed trays on large nurseries, trays for drying harvested fruit, vegetables, seeds.

Composting is a very common operation which consists of performing essentially bacterial aerobic oxidation-reduction of organic materials to produce a humic substrate where nitrogen is mineralized and after which highly polymerized materials such as cellulose are partially degraded. The simplest composting techniques have a metabolic time, or biological retention time, of up to several months which requires a substantial operating area and has high risks of loss of nutrients and particularly of nitrogen by leaching or volatilization. In contrast, elaborate techniques which make it possible to perform an intensified composting operation have a short metabolic time, only use little space and preserve almost all of the native nutrients.

Generally, an intensified aerobic composting method adopts at least the following arrangements:

A device for containerizing the volumes of organic waste or materials treated which can be a covered windrow, a closed bin, a closed corridor or a closed silo in order to protect the treated materials from external damage and to protect the external environment from pollutants which could arise from the composting process.

A system for monitoring temperature and humidity, optionally respiratory flow, in this instance the proportion of CO2 in discharged gases, associated with a device for injecting pure water or an aqueous nutrient solution in order to manage and maintain the most suitable hygrometry at each phase of the process.

With the aid of these devices, a thermophilic aerobic composting method under covered windrows ventilated with controlled moistening is capable of optimally promoting the emergence, proliferation and metabolic activity of aerobic microorganisms which benefit from the increase in the oxygen transfer rate of the pore spaces present in the substrate and which also benefit from the protection of the cover.

In this context, the first so-called initiation phase of composting is mesophilic and very brief, followed by the thermophilic second phase as the substrate reaches during this phase temperatures of the order of 55° C. to 75° C. The thermophilic phase ends spontaneously when the specific microorganisms of this phase disappear, firstly, because they have benefited from enough oxygen to complete the oxidation-reduction of the nutrients available in the substrate and, secondly, when the medium formed by the windrow is no longer favorable for them, particularly in terms of hygrometry or too rich in pore spaces allowing the intrusion of air at a flow rate greater than 0.4 liter per minute. The final phase is curing and mesophilic and can last for a relatively long time until the substrate has completely stabilized, by mineralization and reaching a biochemical equilibrium between the different humic varieties.

An intensified composting method therefore consists of creating an ecosystem wherein the metabolic cyclicity follows the sequence of these three phases while promoting therein biochemical exchanges and an exceptionally active microbiological activity in as little time as possible, therefore in a very reduced volume in relation to a natural method.

In the case of continuous-feed intensified composting methods and to a lesser extent for sequential-feed methods, it is necessary to load the windrows horizontally, i.e. with successive layers, to observe this metabolic cyclicity as the organization in layers is physically consistent with the organization of the cycles and the temperature gradients thereof. The most recent layer is highly breathable and triggers mesophilic bio-oxidation, it receives from the nearest thermophilic lower layers a substantial heat and humidity gain via vertical convection, whereas the lower layers, once broken up, are in a mesophilic cycle with a favorable architecture for pore spaces.

Moreover, the majority of continuous-feed intensified composting methods because they find it advantageous to perform loading in successive layers, must use external mechanical means to the corridors, bins or silos. The simplest of these means consists of using a mechanical wheel loader, the most complex of these means consist of using a high-clearance travelling crane equipped with a loading bin or a belt conveyor with a movable scraper share, which are all costly devices somewhat lacking in precision in the formation of homogeneous substrate layers.

Finally, the accumulation in a closed receptacle of successive layers of materials undergoing composting inevitably results in the compression and compaction of these materials, to such an extent that in a closed receptacle of a certain height the bottommost layer, therefore the most mature layer due to the biological retention time thereof, may be compacted to such an extent that it will no longer flow freely simply due to gravity. To remedy this problem, most installations use a hopper-bottom conveying screw system, but it is not unusual for the hopper geometry per se to increase the compaction phenomenon to the point of producing definitive arching.

Mention will also be made of the French Patent No. 2,473,038, which relates to an installation for converting organic waste into compost. This installation includes at least one parallelepipedal fermentation tower, as well as a horizontal discharge screw. The latter can be actuated in rotation and translation, so as to be able to work over the entire cross-section of the tower.

European Patent Application No. 281 699 has furthermore proposed a composting installation comprising a silo, as well as chambers extending through this silo to supply aeration air. A first conveyor is used to feed the material toward the top of this silo, while an additional conveyer is used for the transfer toward the silo per se.

The teaching of both documents mentioned above belongs to a simple technological background of the present invention.

In view of the above, an aim of the invention is that of remedying, at least partially, the drawbacks of the prior art described above.

A further aim of the invention is that of providing a method for loading a material in layers, along successive layers which are not only regular in thickness, but also distributed in a satisfactory manner.

A further aim of the invention is that of providing such a method, which can be implemented in exchange for particularly low energy expenditure.

A further aim of the invention is that of providing such a method, which can be implemented thanks to a device with a very limited footprint.

A further aim of the invention is that of providing such a method, which can be implemented in a receptacle with a substantial height.

### SUMMARY

According to the invention, at least one of the above aims is achieved by a method for loading a material in layers, wherein

a first fraction of said material intended to form a first layer is fed to a belt conveyor (1) located above a loading zone,

the conveyor is tilted about its longitudinal axis (2), such that the entire first fraction is poured into a receiving zone in a receptacle, in particular a bin, silo or corridor, and thereby said first layer is formed,

a subsequent fraction of the material intended to form a subsequent layer is fed to said conveyor (1),

the conveyor is tilted about its longitudinal axis (2), such that the entire subsequent layer is poured onto the receiving zone and thereby said subsequent layer is formed.

The method according to the invention can comprise all or some of the following features, insofar as they are technically compatible:

the conveyor is tilted about its longitudinal axis in a first direction, such that the entire said first fraction is poured onto the receiving zone, then the conveyor is tilted about its longitudinal axis in a second direction, opposite said first direction, such that the entire said subsequent layer is poured onto the receiving zone,

said first layer formed on the receiving zone is levelled, before tilting the subsequent material fraction,

the containing and decompaction of the layers accumulated in the receptacle are carried out after the trajectory thereof in two successive phases between the tilting conveyor and the receiving zone,

the belt conveyor is fed by means of an upstream conveyor, particularly an oblique belt conveyor or a vertical cup conveyor,

as many successive layers as the feed rate allows are formed, while observing the minimum biological retention times which can vary from 10 days to 30 days according to the composition of the mixture of materials to be treated,

the layered material is formed of organic materials, particularly compost,

each material fraction is poured onto the receiving zone by gravity,

for tilting said conveyor, a dual-action actuator, in which the rod is articulated in relation to said longitudinal axis, is used,

the rod of said actuator is moved in relation to the actuator body, so as to tilt said conveyor,

means for tilting the belt conveyor about its longitudinal axis are used.

The invention also relates to a device for loading a material in layers, particularly organic waste, such as compost, comprising:

a belt conveyor, capable of receiving a fraction of said material,

feeding means, for feeding said belt conveyor with material,

means for tilting the belt conveyor, about its longitudinal axis,

means for receiving said fraction of said material, located plumb with the conveyor.

The device according to the invention can comprise all or some of the following features, insofar as they are technically compatible:

this device further comprises means for containing and decompacting said material fraction, during the trajectory thereof between the conveyor and the receiving zone,

the containing and decompaction means comprise a series of pairs of decompaction rollers assembled horizontally over the entire surface of a silo,

the tilting means comprise a dual-action actuator, in which the rod is articulated in relation to said longitudinal axis,

this device further comprises an upstream conveyor, particularly an oblique cleated belt conveyor or a vertical cup conveyor, capable of feeding said belt conveyor,

this device further comprises automation means, capable of stopping the travel of the conveyor belt when the latter is loaded, and/or automatically alternating the tilting direction of said conveyor,

this device further comprises a discharge conveyor, located downstream from the receiving means, said discharge conveyor being particularly a downstream belt conveyor, or more preferably an endless floor conveyor.

The invention finally relates to an installation for treating a material in layers, particularly such as an intensified composting station in corridor windrows, intensified composting station in silos of rectangular cross-section with continuous top feed and bottom discharge, or unit for drying agricultural or sylvicultural products, said installation comprising at least one loading device as defined above.

The method according to the invention firstly uses a first item of equipment, which enables the continuous feed in layers. This equipment comprises a belt conveyor integrated in the composting receptacle, capable of alternating lateral tilts which enable loading of the windrows with successive and homogeneous layers thus boosting said composting processes, without needing to enlist an external loader or open the composting receptacle. More generally, the present invention also relates to a device which makes it possible to load materials in successive layers inside a receptacle or on a windrow, without involving a mobile external mechanical assembly.

The invention advantageously uses a second item of equipment, which makes it possible to decompact and unload a lower layer of the material. This second item of equipment finds more particularly, but not exclusively, an application in the scenario where the material in layers is formed by compost. This second item of equipment comprises a series of pairs of clod-breaking rollers in opposite rotation, which are disposed midway up the silo and at the bottom of the silo or receptacle. The lower layer of decompacting lump breakers overhangs a belt or endless floor conveyor which receives the broken-up compost by gravity and discharges it outside the receptacle.

The invention according to the present patent application is also based on the dedicated configuration and equipment of a parallelepipedal closed receptacle, such as a bin or silo, of a height advantageously not exceeding 10 meters, of a width advantageously not exceeding 5 meters and a length advantageously not exceeding 20 meters. Preferably, the dimensions of the receptacle do not exceed a height of 6 meters, a width of 2.2 meters and a length of 12 meters. This receptacle is fed with organic materials milled and mixed on the ground in reasonable structuring fraction and volatile fraction proportions.

The material mixture thus prepared is typically conveyed from the ground to the top of the silo by a preliminary conveyor, of the oblique belt or vertical cup type. At the top of the receptacle, the belt conveyor, as described above, receives the materials. When the conveyor is fully loaded, it is stopped then tilted mechanically on one side then the other of the longitudinal axis thereof with an angle that can typically go up to 60°. A mechanical device, composed for example of two metal rakes placed along the receptacle on both sides therefore above the feed layer, is associated with the tilting movement of the conveyor. This device makes it possible, advantageously, to summarily level the two unloading cones formed on each side and underneath the tilting conveyor.

The series of clod-breaking rollers, as described above, is disposed midway up the receptacle and at the bottom of the receptacle. These layers cover the entire horizontal surface of the receptacle. The first is located about 3 meters below the level of the tilting conveyor and the second around 1 meter from the receiving surface of a belt conveyor or an endless floor conveyor, disposed at the bottommost point of the receptacle at ground level. The most mature compost is therefore that of the bottommost layer and it bears on the clod-breaking rollers of the bottommost layer.

According to the method described in French Patent No. 2,936,519, a dual aeraulic device, a sprinkling device and a leachate collection system advantageously supplement the equipment of the receptacle. The dual aeraulic device is typically composed, on one hand, of an air compressor capable of injecting about twice the effective volume of the silo in one hour with a pressure of about 200 kPa and, on the other, a booster fan capable of drawing one time the volume of the receptacle in one hour and injecting this volume with a pressure of about 20 kPa. The compressor forms the basis of the primary ventilation, for this purpose, it injects external air into the receptacle just below the line of the two layers of decompactors with different flow rates which meet the needs of the two phases. The booster fan forms the basis of the secondary ventilation, for this purpose, it draws the “breathing” air into the top of the receptacle above the layer of fresh materials and reinjects it above the belt or endless floor conveyor, which discharges the broken-up compost so as to aerate the mature compost which is stored therein pending discharge. The mature compost ready to be discharged therefore acts as a biological filter as it captures the olfactory organic fillers carried by the breathable vapor from the top of the receptacle, which also has the effect of canceling nutrient losses by volatilization.

The sprinkling ramp, placed above the top layer of fresh materials, is distributed into several pipes that are perforated or equipped with sprinklers or nozzles according to the type of moistening fluid which also defines the tube diameter. The configuration thereof is such that the distribution of the fluid is performed equitably over the entire surface of the top layer of fresh materials without impeding the tilting of the feed conveyor. One or two additional ramps of small size may be disposed at lower stages of the silo to improve the moistening in the case of materials having a strong tendency toward compaction.

Typically, the leachate collection system is essentially composed of a receiving drain placed at the mature compost outlet end slightly below the discharge conveyor, the receptacle being installed on side with a slight longitudinal slope (3% maximum) in which the bottommost point is on the mature compost outlet side. This collecting drain parallel with the lesser side of the receptacle is in turn connected by gravity to a buried tank having a device for separating solid materials (such as a baffle with removable filtering tray) and can accommodate a submerged lifting pump or the strainer or a surface pump.

The benefit of this arrangement of dedicated equipment and devices is obvious for intensified composting installations, with bin or silo type receptacles, because it makes it possible to load the windrows from the top of the silo in well-distributed successive layers of regular thickness. Furthermore, the receptacle can be relatively high and incorporate at the top level the device for feeding in successive layers which only requires very little energy to function, unlike standard external mechanical means or complex and imprecise mechanical means which would also have difficulty operating at heights greater than 5 meters.

The advantage of such a closed composting ecosystem is that of setting up and easily maintaining phase separation; the top layer is mesophilic at initiation over about 200 mm, whereas from 200 mm to the first row of decompactors, i.e. at the core of the windrow, the microbiological status is clearly thermophilic. In the case where the second row of decompactors proved to be necessary (highly volatile waste with a high biodegradability requirement), it is possible to install a second row of decompactors and up to which the microbiological metabolism will become gradually mesophilic. In any case, the materials extracted and kept in the discharge corridor are in decreasing mesophilic activity typical of the end of curing. The biological regulation which enables this phase separation, due to precise aeraulic and hydraulic management of the windrow was developed in French Patent No. 2,936,519.

A further advantage of this silo or bin system is that it only has a very small footprint compared to a windrow or corridor system while ensuring perfect control of the environmental risks associated with emissions of breathing gases or leachates which can give rise to health risks (“farmer's lung”), olfactory or biological risks.

Finally, the clod breaking makes it possible not only to overcome the compaction which would be otherwise inevitable at the bottom of the receptacle, but also to reduce the grain size of the compost and measure the discharge volume thereof in equilibrium with the feed volume.

### DRAWINGS

The invention will be described hereinafter, with reference to the appended drawings, given merely by way of non-limiting example, wherein:

FIG. 1 is an end view, illustrating a treatment installation equipped with a device for loading a material in layers, suitable for use thanks to the loading method according to the invention.

FIG. 2 is a front view, illustrating the treatment installation in FIG. 1.

FIG. 3 is a front view, illustrating the loading device belonging to the installation in FIGS. 1 and 2.

FIG. 4 is a top view, illustrating the loading device belonging to the installation in FIGS. 1 and 2.

FIG. 5 is an end view, illustrating the loading device belonging to the installation in FIGS. 1 and 2.

FIG. 6 is a front view similar to FIG. 3, illustrating further design details of the loading device in FIGS. 3 to 5.

FIG. 7 is a top view similar to FIG. 4, illustrating further design details of the loading device in FIGS. 3 to 5.

FIG. 8 is an end view similar to FIG. 4, illustrating further design details of the loading device in FIGS. 3 to 5.

FIG. 9 is an end view, illustrating a first functional position of the loading device, implemented according to the loading method according to the invention.

FIG. 10 is an end view, illustrating a second functional position of the loading device, implemented according to the loading method according to the invention.

FIG. 11 is an end view, illustrating a third functional position of the loading device, implemented according to the loading method according to the invention.

FIG. 12 is a perspective view, illustrating a treatment installation according to an alternative embodiment of the invention.

### DESCRIPTION

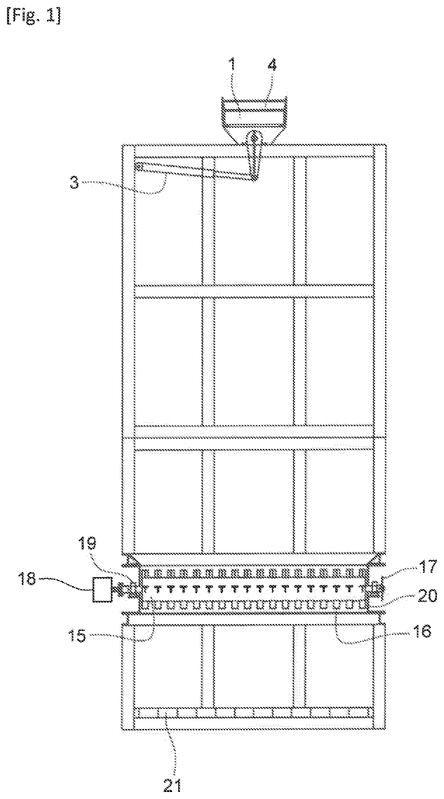

The loading device according to the invention mainly comprises a belt conveyor (1), a longitudinal axis (2), a tilting device (3), an automation device (4), as well as optionally two rakes for levelling the discharging cones, formed of any suitable material. As seen in particular in FIGS. 1 and 2, this loading device is placed at the top part of an installation for treating the material, initially loaded by means of this device.

The belt conveyor (1) generally comprises a frame (5) composed of two side rails with spacers and rollers and a loading belt composed preferably of a series of planar meshes (6) organized in chains rather than a coated woven belt or belt optionally made of elastic composite. One or more rollers must be motorized by external connection to an electric or hydraulic motor or with a motor integrated in some rollers. Lateral guides disposed from place to place on the side of and along the conveyor belts, on the top face thereof, advantageously prevent the offset of said belt under the effect of gravity when the conveyor is tilted.

The longitudinal axis (2) is, most simply, composed of a tube (8) traversing triangular supports (9) to which it is attached, and which are connected at the top to the bottom of the frame of the conveyor (5). At each of its ends, this tube rests on a bearing (10) and at one thereof it is connected to a perpendicular arm, or coupling arm (11) which is connected to the tilting device (3).

The tilting device (3) is, most simply, composed of a dual-action actuator (3), which is hydraulic or pneumatic, optionally electric for small installations. The end of the cylinder (13) of this actuator is articulated on a fixed support and the end of the piston rod of the actuator (14) is articulated on the lower end of the coupling arm (11). The actuator is placed perpendicularly to the coupling arm (11) to which it communicates a thrust in one direction and a traction in the other direction which induce a half-rotation of the longitudinal axis, thereby actuating in the partial rotation thereof the frame of the belt conveyor. The return of the conveyor of the conveyor to the horizontal position results from an intermediate thrust or traction which returns the coupling arm (11) to the vertical position.

The automation device (4), which has a dual purpose, makes it possible on one hand to stop the travel of the belt of the conveyor (6) automatically when the latter is loaded satisfactorily along the entire length thereof. Moreover, it makes it possible to automatically alternate tilting on one side to the other of the axis of the conveyor (2). For the first need, this device can reasonably result from the use of a photoelectric cell (4) placed at the end of the conveyor at the level of the average uppermost point of the load thereof and the beam whereof will be interrupted when the loading interferes between the emitter and the receiver of the cell. This cell, which is connected to a relay which closes or opens the power supply circuit of the conveyor motors, also controls the activation of the second automation device by a relay.

An electromechanical device (4) composed for example of a contact plate disposed perpendicularly to the belt of the conveyor at the output end and moved by the thrust of the load conveyed at the end of travel, may represent a quite effective alternative. This plate pivoting on an upper horizontal axis assisted preferably by an adjustable-tension spring, will be connected to a spring-mounted contactor which will activate the set of relays.

The automation of the alternating tilting can be electromechanical for example, via the use of a two-state switch which is activated in contact with a push-button strategically disposed at the bottommost point on one side or the other of the frame of the conveyor, so that it coincides with the maximum cyclic travel thereof. The dual-action contactors open or close a circuit which controls the thrust or retraction of the actuator, which in turn moves the coupling arm. Failing electromechanical means, photoelectric cells or any other electronic device, of a type known per se, may be used with the same effectiveness.

The decompaction and discharge equipment is essentially composed of the assembly of clod-breaking equipment disposed in pairs across the entire width of the silo and horizontally along the entire length. Each pair comprises two clod-breaking cylinders (15) equipped with teeth, the arrangement whereof can vary according to the composition of the materials to be decompacted. The cylinders are moved preferably by a hydraulic motor (18) engaged on an end of one of the cylinders, the motricity connection with the other cylinder being provided either by a set of gear-trains (17), placed at the other end of the pair and which also makes it possible to obtain a rotation in the opposite direction in the clod-breaking pair. Another movement solution will consist of a system of chains associated with gear-trains engaged at each side of the axes of the rollers, the hydraulic motor actuating a motor gear-train. Another movement alternative can finally consist of an actuator which actuates transfer rods associated with a universal joint engaged with disks in turn associated with the axes of the rollers. These stainless or galvanized steel cylinders must have a sufficient thickness and diameter so as not to bend under the mass of the compost which bears thereon and so that the torque load remains within the limits of elasticity of the system. The cylinders (15) are equipped over the entire outer surface thereof with a set of steel teeth (16) wherein the shape and size which mostly determines the cutting, pulling and extraction power of the clod-breaking pairs is adapted to the type of compost to be mobilized.

At the ends thereof, the clod-breaking cylinders rest in bearings (19), in turn set up on a strutted steel beam (20) between each pair of cylinders with a vertical blade, which is rewelded onto the upper beam. The arrangement of these resting structures must not only ensure the rigidity of the system, but it must also enable the removal of a pair of cylinders without having to disassemble the entire clod-breaking assembly.

Advantageously, a horizontal discharge conveyor (21) completes this device. It is placed below, typically at about 1 meter, the clod-breaking cylinder assembly (15), and can be composed of a heavy-duty extra-wide belt conveyor or preferably of an endless floor conveyor. The role of this device is firstly that of collecting the compost produced by the clod breaking and storing it for a few hours (e.g. 24 hours) without any risk of leaching, then discharging it from the silo in a reduced time before receiving a new load. An insufflation line is disposed at either end of the conveyor or at the midpoint thereof to diffuse, in the curing windrow thus formed on the conveyor, breathing air drawn at the top of the silo. The discharge corridor is therefore closed at both ends thereof, but a filtered air outlet is arranged in the exit door.

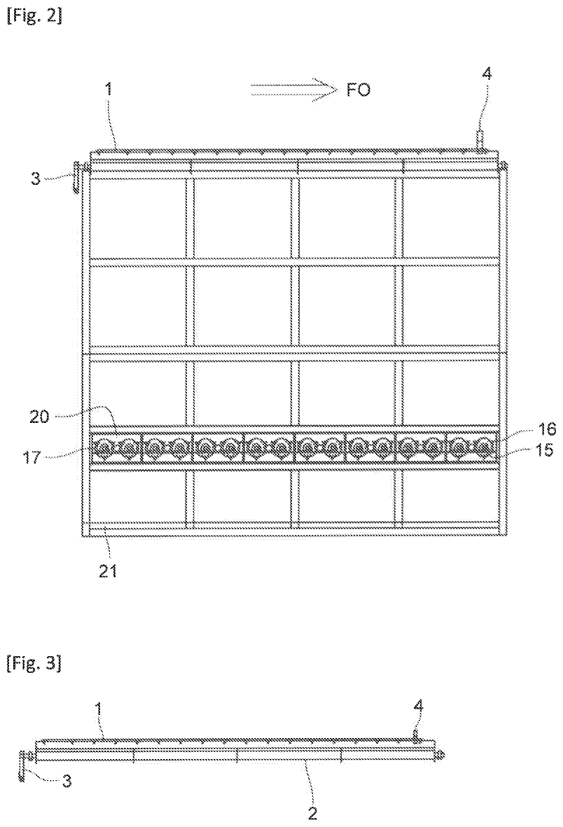

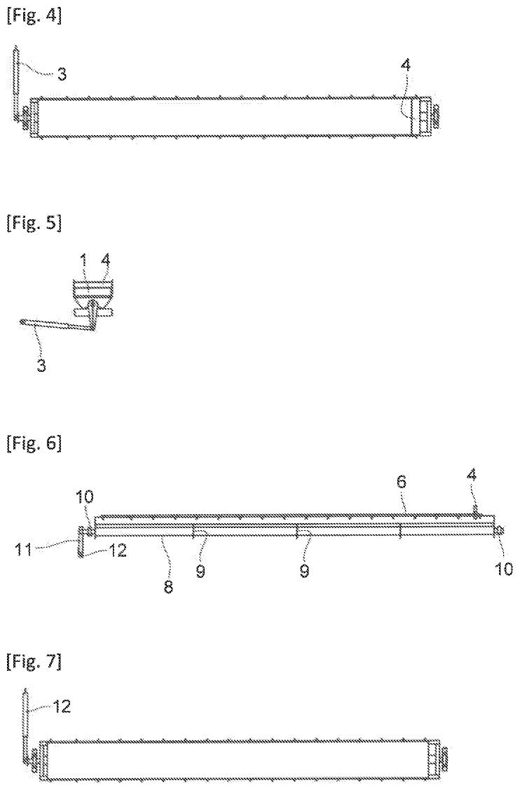

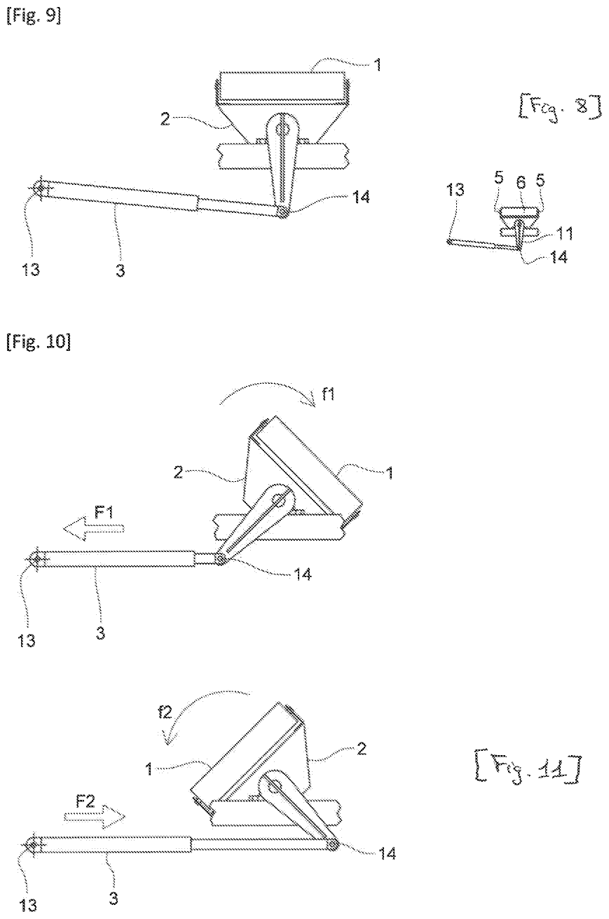

The commissioning of the loading device, as described above, will be explained below with reference to FIGS. 1 to 11.

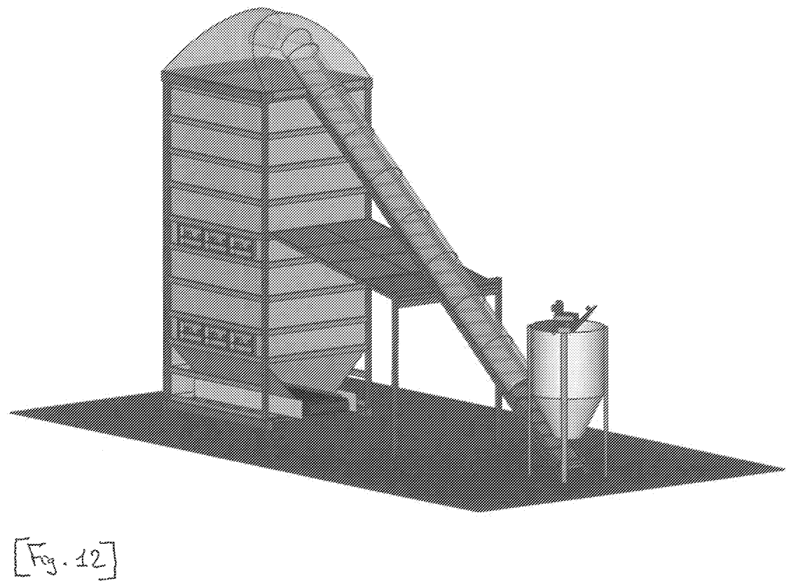

It is assumed firstly that the upstream conveyor, not shown, is located to the left of the loading device, in FIG. 1. The belt conveyor is started up, along the arrow F0, while actuating the upstream conveyor cited above. Consequently, a first fraction of the material, intended to be loaded thanks to this device, is fed onto the belt of this conveyor. When the material occupies the entire belt, this event is detected by the automation device (4), and the upstream conveyor and the main conveyor are stopped. Then, the actuator rod is moved along the arrow F1, so as to pivot the conveyor about the longitudinal axis thereof along the arrow f1, as shown in FIG. 10. The first fraction of the material, initially present on the belt surface, is then discharged onto the loading zone so as to form a first layer.

The basic operation above is started once again, so as to feed a second fraction of the material on the conveyor belt. When this second fraction occupies the entire belt, the two conveyors are stopped. Then, as shown in FIG. 11, the actuator rod is moved along the arrow F2, that is to say in an opposite direction to that of the movement thereof represented by the arrow F1. The conveyor then pivots about the main axis thereof along the arrow f2, that is to say along an opposite tilting direction to that represented by the arrow f1. The second fraction of the material, initially present on the belt surface, is then discharged onto the loading zone so as to form a second layer.

The basic operations above are repeated, so as to form a material thickness formed of as many layers as the silo feed allows, while observing the minimum biological retention time. Between two successive basic operations, the top layer, that is to say that which has just been discharged, is advantageously leveled.

Different examples of embodiment of the invention, relating to an intensified composting method used in various industrial treatment installations, will now be described. More specifically, we describe below an illustration of the use of the invention successively in these types of composting stations, then in an agricultural product drying application.

In a typical corridor windrow intensified composting station, the input materials, i.e., a mixture of milled structuring and volatile organic waste, are disposed as usual, thanks to a wheel loader. This vehicle removes a load with its bucket at the mixing mill outlet and will dispose it in the corridor windrow starting from the bottom of the windrow up to the open end thereof. The load is therefore vertical and sequential, each dose loaded covers the entire height of the windrow. The ground of the corridor windrow usually comprises one or more forced ventilation lines and optionally lateral moistening devices. In preferred configurations, a tarp or any other equivalent device is used to cover the windrows.

In continuous feed mode, these devices are not fully optimized in that the loading is not performed in successive layers, the first loads (at the end of the corridor) being more mature do not benefit from the insufflated air and must not be overly hydrated, the intermediate loads (in the middle of the corridor) have a decreasing requirement but still substantial hydric requirements, whereas the final loads (at the start of the corridor) need intense supplies. Furthermore, each load requires that the tarp or the covering device be partially removed or taken off.

A belt conveyor disposed at the apex of each corridor will make it possible to:

Every day, feed all or some of the corridor windrows according to input material availability by disposing successive layers of variable thickness on the entire surface of each windrow with only two small loading edges rather than a single large edge.

Every day, adjust the insufflation from the bottom and the moistening from the top according to the loading height of each windrow and particularly the incremented daily load in a layer.

Leave the windrow covered throughout loading insofar as the lateral-tilt conveyor can be very readily mounted on a mobile frame.

Furthermore, this device will make it possible to avoid:

The use and operation of a wheel loader, which requires a substantial area for maneuver for each windrow, since the milling and mixing device may be mobile and placed at the start of the conveyor and load it directly.

Frequent turning of the windrows since a single turning operation midway through the biological retention time will suffice to initiate a mesophilic phase (according to the teaching of French Patent No. 2,936,519).

In a containerized intensified composting station, the input materials, i.e. a mixture of milled structuring and volatile organic waste, are disposed as usual, thanks to a wheel loader. This vehicle removes a load with its bucket at the mixing mill outlet and will dispose it in the bin performing as many offset maneuvers as possible so as to form a rough form of homogeneous layers in height. However, unless a mechanical levelling device is available or workers performing this levelling inside the bin are available, the layers obtained will be geometrically irregular. The bin usually comprises one or more forced ventilation lines at the bottommost point thereof and optionally lateral moistening devices. In preferred configurations, a tarp or a rigid cover can be used to cover the bins. For the same reasons as explained above, in continuous feed mode, these devices are not fully optimized in that loading is not performed in homogeneous successive layers in geometrical terms.

A belt conveyor fed by an inclined conveyor, in turn receiving its load from the mixing mill, and disposed at the apex of each bin in the axis thereof and at the center thereof will make it possible to:

Every day, feed all or some of the bins according to input material availability by disposing successive layers of variable thickness on the entire surface of each bin with only two small loading edges rather than a single large edge.

Every day, adjust the insufflation from the bottom and the moistening from the top according to the loading height of each windrow and particularly the incremented daily load in a layer.

Leave the bin covered throughout loading insofar as the lateral-tilt conveyor can perfectly well be mounted on a rail-mounted mobile frame servicing several bins.

Furthermore, this device will make it possible to avoid:

The use and operation of a wheel loader, which requires a substantial area for maneuver for each bin, since the milling and mixing device may be mobile and placed at the start of the inclined conveyor and load it directly.

Frequent turning of the windrows since a single turning operation midway through the biological retention time will suffice to initiate a mesophilic phase (according to the teaching of French Patent No. 2,936,519).

In an intensified composting station in silos of rectangular cross-section with continuous top feed and bottom discharge, the input materials, i.e. a mixture of milled structuring and volatile organic waste, are disposed as usual, thanks to a telescopic-arm loader, the pre-composted or composted substrates being extracted from the bottom of the silo thanks to a clod breaker or any other equivalent device which loads a belt or screw discharge conveyor. The maneuvers of this vehicle and the effect of these maneuvers are similar to the description above, with additionally the difficulty of steering a bucket at the end of a fork or a telescopic arm. Moreover, for the same reasons as explained above, in continuous feed mode, these devices are not fully optimized in that loading is not performed in homogeneous successive layers in geometrical terms. This failing is especially important as, in silos, up to 6 m or more of substrate can be accumulated.

A belt conveyor fed by an inclined conveyor, in turn receiving its load from the mixing mill, and disposed at the apex of each silo in the axis thereof and at the center thereof will make it possible to:

Every day, feed all or some of the bins according to input material availability by disposing successive layers of variable thickness on the entire surface of each bin with only two small loading edges rather than a single large edge.

Every day, adjust the insufflation from the bottom and the moistening from the top according to the loading height of each windrow and particularly the incremented daily load in a layer.

Leave the bin covered throughout loading insofar as the lateral-tilt conveyor can perfectly well be mounted on a rail-mounted mobile frame servicing several bins.

Furthermore, this device will make it possible to avoid:

The use and operation of a telescopic wheel loader, which requires a substantial area for maneuver for each bin, since the milling and mixing device may be mobile and placed at the start of the inclined conveyor and load it directly.

In a unit for drying agricultural or sylvicultural products, it is frequently required to dispose damp substrates such as leaves, straw, coarse sawdust, shredded wood or bark in a rectangular receptacle closed on all sides, such as a bin or a silo, which receives at the bottom thereof a supply of hot or very hot air depending on the products and the process used. Generally, the moist air resulting from the injection of hot primary air is evacuated by natural convection or by suction at the uppermost point of this receptacle and at the end of a cycle, the drying sought for the treated substrates is obtained. However, if, in this bin or this silo, geometrically irregular loading is performed, as described above, because the loading means is a bucket loader, the drying will be incomplete in some zones of the treated product, because the natural or forced convection by suction at the uppermost point will circulate more or less moist air in the loading hollow zones.

Traditional drying is also frequently performed by exposure to the wind and sun for materials that cannot be accumulated in thick layers, this is the case for example of milled products from cassava, coffee and cocoa beans, vanilla pods. This traditional drying, requiring automation however in industrial configurations is performed in shallow trays, often with a wire mesh bottom and cover. Mechanical loading with manual levelling or fully manual loading makes it possible to form geometrical homogeneous layers. However, such a practice tends to disqualify businesses economically due to their high operating cost particularly for low added-value products. The use of a lateral-tilt conveyor fed by an inclined conveyor disposed above a filling bank which receives the drying trays will obviously provide balanced loads, which are much easier to level with an improved throughout while retaining the traditional product treatment method.

FIG. 12 illustrates an alternative embodiment of the invention. According to this embodiment, the loading method described above is implemented, in particular with the decompaction devices thereof, in a silo of square or rectangular cross-section of small dimensions. In that vein, it consists for example of the lesser side of a 20-foot container, the dimensions whereof are typically 2.20 m by 2.70 m.

This embodiment does not necessarily make use of the upper lateral-tilt conveyor described above. However, all the other mechanical elements described and claimed can be incorporated in this embodiment, according to all the technically compatible combinations for a person skilled in the art.

1-20. (canceled)

21. A method for loading a material in layers, the method comprising:
feeding a first fraction of the material intended to form a first layer to a belt conveyor located above a loading zone;
forming the first layer by tilting the belt conveyor about its longitudinal axis such that the first fraction in its entirety is poured into a receiving zone in a receptacle;
feeding a subsequent fraction of the material intended to form a subsequent layer to the belt conveyor; and
forming the subsequent layer by tilting the belt conveyor about its longitudinal axis such that the subsequent layer in its entirety is poured onto the receiving zone.

22. The method of claim 21, wherein:
forming the first layer comprises tilting the belt conveyor about its longitudinal axis in a first direction such that the first fraction in its entirety is poured onto the receiving zone, and
forming the subsequent layer comprises tilting the belt conveyor about its longitudinal axis in a second direction opposite said first direction such that the subsequent layer in its entirety is poured onto the receiving zone.

23. The method of claim 21, further comprising, after forming the first layer and before forming the subsequent layer, levelling the first layer formed on the receiving zone.

24. The method of claim 21, wherein containing and decompaction of the first layer and the subsequent layer accumulated in the receptacle are carried out after a trajectory thereof in two successive phases between tilting the belt conveyor and the receiving zone.

25. The method of claim 21, wherein the belt conveyor is fed via an oblique cleated belt conveyor or a vertical cup conveyor located upstream of the belt conveyor.

26. The method of claim 21, further comprising forming as many successive layers as a feed rate allows, while observing a minimum biological retention times which vary from 10 days to 30 days according to a composition of a mixture of materials to be treated.

27. The method of claim 21, wherein the material comprises organic materials.

28. The method of claim 21, wherein the belt conveyor is tilted about its longitudinal axis via a tilting device.

29. The method of claim 21, wherein an automation device is used to stop movement of the belt conveyor when the belt conveyor is loaded, and/or automatically alternate a tilting direction of the belt conveyor.

30. The method of claim 21, wherein each material fraction is poured onto the receiving zone by gravity.

31. The method of claim 21, wherein the belt conveyor is tilted about its longitudinal axis via a dual-action actuator having an actuator body and a rod which is articulated in relation to the longitudinal axis.

32. The method of claim 31, wherein tilting the belt conveyor about its longitudinal axis comprises moving the rod of the dual-action actuator in relation to the actuator body.

33. A loading assembly for loading a material in layers, the assembly comprising:
a belt conveyor operable to receive a fraction of the material;
a feeding device operable to feed the belt conveyor with the material;
a tilting device operable to tilt the belt conveyor about a longitudinal axis of the belt conveyor; and
a receptacle having a receiving zone to receive the fraction of the material.

34. The loading assembly of claim 33, further comprising a device for containing and decompacting the fraction of the material during trajectory thereof between the belt conveyor and the receiving zone.

35. The loading assembly of claim 33, wherein the device for containing and decompaction comprise a series of pairs of rollers.

36. The loading assembly of claim 33, wherein the tilting device comprises a dual-action actuator having a rod which is articulated in relation to the longitudinal axis of the belt conveyor.

37. The loading assembly of claim 33, further comprising an oblique cleated belt conveyor or a vertical cup conveyor, located upstream of the belt conveyor, operable to feed the belt conveyor.

38. The loading assembly of claim 33, further comprising a discharge conveyor, located downstream from the receptacle, operable to receive formed layers of the material.

39. The loading assembly of claim 33, further comprising an automation device operable to stop movement of the belt conveyor belt when the belt conveyor is loaded with the material, and/or automatically alternating a tilting direction of the belt conveyor.

40. An installation system for treating a material in layers, the installation system comprising:
a loading assembly for loading the material, the assembly including:
a belt conveyor operable to receive a fraction of the material,
a feeding device operable to feed the belt conveyor with the material,
a tilting device operable to tilt the belt conveyor about a longitudinal axis of the belt conveyor, and
a receptacle having a receiving zone to receive the fraction of the material.
